(19) United States
(12) Patent Application Publication
(10) Pub. No.: US 2021/0139028 A1
(43) Pub. Date: May 13, 2021

(54) FUZZY LOGIC BASED AND MACHINE LEARNING ENHANCED VEHICLE DYNAMICS DETERMINATION

(71) Applicant: SF Motors, Inc., Santa Clara, CA (US)

(72) Inventors: Xingyu Zhou, Santa Clara, CA (US); Junzhe Shi, Santa Clara, CA (US); Min Tian, Santa Clara, CA (US)

(21) Appl. No.: 16/682,895

(22) Filed: Nov. 13, 2019

(51) Int. Cl. B60W 30/14; B60W 30/04; B60W 10/20; G06N 20/00; G06N 5/04

(52) U.S. Cl. CPC B60W 30/143; B60W 30/04; B60W 10/20; G06N 20/00; G06N 5/048; B60W 2030/041; B60W 2520/105; B60W 2520/20; B60W 2520/28; B60W 2520/16; B60W 2520/18; B60W 2520/125; B60W 2030/043

(57) ABSTRACT

Fuzzy logic based and machine learning enhanced vehicle dynamics determination is provided. A system can identify a previous longitudinal velocity and receive data from an inertia measurement unit. The system can determine a roll angle and a pitch angle. The system can determine a lateral acceleration and a longitudinal acceleration. The system can receive wheel speed sensor data, tire pressure sensor data, and steering angle sensor data, and use the data to determine a longitudinal velocity. The system can select one of a reduced-order non-linear Luenberger observer technique or a reduced-order Kalman filter technique. The system can determine a lateral velocity and a sideslip angle. The system can provide the lateral velocity and the sideslip angle to a vehicle controller.

### BACKGROUND

Vehicles such as automobiles can include can include sensors. The sensors can determine the speed or acceleration of the vehicle.

### SUMMARY

At least one aspect is directed to a system to control vehicle dynamics. The system can include a data processing system having one or more processors and memory. The data processing system can execute a vehicle longitudinal and lateral observer (“VLLO”) component, a vehicle longitudinal dynamics observer (“VLDO”) component, and a vehicle side slip observer (“VSSO”) component. The VLLO component can identify, for a previous time interval, a previous longitudinal velocity of a vehicle. The VLLO component can receive, for a current time interval, data from an inertia measurement unit of the vehicle. The VLLO component can determine a roll angle for the vehicle for the current time interval and a pitch angle for the vehicle for the current time interval based on the data and the previous longitudinal velocity for the previous time interval. The VLLO component can determine a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle. The VLDO component can receive wheel speed sensor data for each of a plurality of wheels of the vehicle, tire pressure sensor data for each of the plurality of wheels of the vehicle, and steering angle sensor data. The VLDO component can identify the previous longitudinal velocity for the previous time interval. The VLDO component can identify the lateral acceleration and the longitudinal acceleration for the current time interval determined by the vehicle longitudinal and lateral observer component. The VLDO component can determine a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval. The VSSO component can select one of a reduced-order nonlinear Luenberger observer technique or a reduced-order Kalman filter technique based on the confidence index of the VLLAO component and the confidence index of the VLDO component. The VSSO component can determine, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval. The VSSO component can provide the lateral velocity and the sideslip angle for the current time interval to a vehicle controller to cause the vehicle controller to control movement of the vehicle.

At least one aspect is directed to a method of controlling vehicle dynamics. The method can be performed by a data processing system having one or more processors and memory. The method can include the data processing system executing a vehicle longitudinal and lateral observer (“VLLO”) component, a vehicle longitudinal dynamics observer (“VLDO”) component, and a vehicle side slip observer (“VSSO”) component. The method can include VLLO component identifying, for a previous time interval, a previous longitudinal velocity of a vehicle. The method can include the VLLO component receiving, for a current time interval, data from an inertia measurement unit of the vehicle. The method can include the VLLO component determining a roll angle for the vehicle for the current time interval and a pitch angle for the vehicle for the current time interval based on the data and the previous longitudinal velocity for the previous time interval. The method can include the VLLO component determining a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle. The method can include the VLDO component receiving wheel speed sensor data for each of a plurality of wheels of the vehicle, tire pressure sensor data for each of the plurality of wheels of the vehicle, and steering angle sensor data. The method can include the VLDO component identifying the previous longitudinal velocity for the previous time interval. The method can include the VLDO component identifying the lateral acceleration and the longitudinal acceleration for the current time interval determined by the vehicle longitudinal and lateral observer component. The method can include the VLDO component determining a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval. The method can include the VSSO component selecting one of a reduced-order nonlinear Luenberger observer technique or a reduced-order Kalman filter technique based on the confidence index of the VLLAO component and the confidence index of the VLDO component. The method can include the VSSO component determining, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval. The method can include the VSSO component providing the lateral velocity and the sideslip angle for the current time interval to a vehicle controller to cause the vehicle controller to control movement of the vehicle.

At least one aspect is directed to a vehicle. The vehicle can include a data processing system having one or more processors and memory. The data processing system can execute a vehicle longitudinal and lateral observer (“VLLO”) component, a vehicle longitudinal dynamics observer (“VLDO”) component, and a vehicle side slip observer (“VSSO”) component. The VLLO component can identify, for a previous time interval, a previous longitudinal velocity of the vehicle. The VLLO component can receive, for a current time interval, data from an inertia measurement unit of the vehicle. The VLLO component can determine a roll angle for the vehicle for the current time interval and a pitch angle for the vehicle for the current time interval based on the data and the previous longitudinal velocity for the previous time interval. The VLLO component can determine a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle. The VLDO component can receive wheel speed sensor data for each of a plurality of wheels of the vehicle, tire pressure sensor data for each of the plurality of wheels of the vehicle, and steering angle sensor data. The VLDO component can identify the previous longitudinal velocity for the previous time interval. The VLDO component can identify the lateral acceleration and the longitudinal acceleration for the current time interval determined by the vehicle longitudinal and lateral observer component. The VLDO component can determine a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval. The VSSO component can select one of a reduced-order nonlinear Luenberger observer technique or a reduced-order Kalman filter technique based on the confidence index of the VLLAO component and the confidence index of the VLDO component. The VSSO component can determine, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval. The VSSO component can provide the lateral velocity and the sideslip angle for the current time interval to a vehicle controller to cause the vehicle controller to control movement of the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a block diagram depicting an example system to determine vehicle dynamics, in accordance with an implementation;

FIG. 2 depicts a flow diagram depicting an example operation of a system to determine vehicle dynamics, in accordance with an implementation;

FIG. 3 depicts a flow diagram depicting an example operation of a vehicle longitudinal and lateral acceleration observer component, in accordance with an implementation;

FIG. 4 depicts a flow diagram depicting an example operation of a vehicle longitudinal dynamics observer component, in accordance with an implementation;

FIG. 5 depicts a flow diagram depicting an example operation of a vehicle side slip observer component, in accordance with an implementation;

FIG. 6 depicts a flow diagram depicting an example method of determining vehicle dynamics, in accordance with an implementation; and

FIG. 7 is a block diagram illustrating an architecture for a computer system that can be employed to implement elements of the systems and methods described and illustrated herein, including, for example, the systems depicted in FIGS. 1 and 2, and the operations, methods or examples depicted in FIGS. 3-6.

### DETAILED DESCRIPTION

Following below are more detailed descriptions of various concepts related to, and implementations of, methods, apparatuses, and systems of vehicle dynamics determination. The various concepts introduced above and discussed in greater detail below may be implemented in any of numerous ways.

Systems and methods of this technical solution are directed to fuzzy logic based and machine learning enhanced vehicle dynamics determination. Driver assist or autonomous vehicle functionality can use information about vehicle dynamics to perform various functions, such as adaptive cruise control or autonomous driving. However, it can be challenging to develop accurate, reliable, and efficient vehicle dynamics determination techniques in an efficient and economical manner due to the complexity of the structure of the vehicle, the high degree-of-freedom (DOF), the high nonlinearity embedded in vehicle dynamics, and the unpredictable stochastic environmental noise and disturbances.

Sophisticated hardware sensors, such as radar, lidar, camera sensors, or high-accuracy Global Positioning System (“GPS”), may directly measure or enhance the estimation for the vehicle dynamical states. However, such sophisticated hardware sensors are expensive, add excess weight to the vehicle, can consume excess battery power, and significantly increase the cost of the vehicle. Thus, using sophisticated sensors can decrease the performance or range of a vehicle. In some cases, less expensive sensors can use an unscented Kalman filter based on the nonlinear vehicle dynamics state space model. While such an estimation function may generate an accurate estimation, it may be computationally resource intensive, thereby introducing computing delay in real-time applications or consume excess battery power or other computing resources. For example, since this function is based on nonlinear vehicle dynamics state space model, the online estimation function regarding the related vehicle parameters is concurrently implemented, which creates inefficiencies or drawbacks. For example, the difficulty and the workload of the experimental tuning and calibration of the final estimation function may be dramatically increased because of the addition of the online vehicle parameters (e.g. vehicle mass and moment of inertia, tire cornering stiffness, tire loads, axel lateral force, etc.) estimation functions. Additionally, more computation power is may be used to accomplish the estimation, which is likely to introduce large time delay to the system and may use more expensive chips and boards.

Systems and methods of this technical solution can provide fuzzy logic based and machine learning enhanced vehicle dynamics determination in an efficient manner without using sophisticated sensors or introducing excessive delays in real-time or online computation and applications. This technical solution can provide an accurate, reliable, efficient, yet commercially economic results that include providing the longitudinal vehicle velocity/wheel slip ratio and the lateral velocity and vehicle side slip angle. To do so, and for example, the first way in which this technical solution provides an improvement may be by not using expensive hardware sensors such as radar, lidar and camera sensors, or high-accuracy GPS. Instead, this technical solution can use sensors such as 6-DOF (“degree of freedom) Inertia Measurement Unit (“IMU”), wheel speed sensors, steering angle sensors, and tire pressure sensor. These sensors may be less expensive than sophisticated sensors such as lidar, radar or camera, or high-accuracy GPS. Second, and for example, this technical solution can provide an improvement by being based on a linear single-track kinematic vehicle model. Compared to dynamic vehicle state space model, the kinematic model is geometrical and independent of any vehicle parameters. As a result, this technical solution avoids the development of vehicle parameters estimation functions. Third, and for example, this technical solution can provide an improvement by decoupling the estimation processes into two parts: (i) estimating the longitudinal dynamics first, and then (ii) estimating the lateral dynamics. The decoupled estimation process can lead to improvements and advantages, such as reducing the order of the kinematic state space model thereby allowing the development of reduced-order observers (reduced-order nonlinear Luenberger observer and Kalman Filter). This decoupling of the estimation processes can significantly reduce the difficulty and workload of design, tuning, calibration, firmware implementation, and computational power relative to a coupled estimation process. Fourth, this technical solution can provide an improvement by implementing a machine learning enhanced wheel speed processor. The machine learning function can be equipped with anomaly detection which can enhance the reliability of the overall estimation function. Fifth, this technical solution can provide an improvement by implementing one or more fuzzy logic based function, including fuzzy logic based covariance adjustment for Kalman Filter and fuzzy logic based observer selector for vehicle side slip estimation functions. The fuzzy logic technique can improve accuracy and robustness of the estimation functions, and also lead to the optimization of computation power allocation.

For example, a data processing system of the present technical solution can use hardware sensors including the 6-DOF IMU, wheel speed sensor, steering angle sensor, and tire pressure sensor. The data processing system can be programmed using C code and include hardware chips and a board that is configured for real-time computation.

This technical solution can include one or more components, such as a Vehicle Longitudinal and Lateral Acceleration Observer (“VLLAO”) component, a Vehicle Longitudinal Dynamics Observer (“VLDO”) component, and a Vehicle Side Slip Observer (“VSSO”) component. The VLLAO component can obtain the IMU signals as inputs. The VLLAO component can use the IMU signals to determine or estimate the roll and pitch angle of the vehicle, and then determine or estimate the longitudinal and lateral acceleration at the center-of-gravity (“COG”). The VLLAO component can generate a confidence index (“CI VLLAO”). The VLDO component can obtain the measured wheel speed, steering angle tire pressure, and the determined or estimated vehicle longitudinal acceleration and yaw rate from VLLAO as inputs, and then output the estimated vehicle longitudinal velocity/wheel slip and a confidence index (“CI VLDO”). The VSSO component can obtain the yaw rate from VLLAO component and the estimated vehicle longitudinal velocity and CI VLDO from the VLDO component, and then output the determined or estimated vehicle lateral velocity and side slip angle.

The processes performed by the VLLAO component, VLDO component, and VSSO component can be decoupled with regard to the longitudinal and lateral dynamics, which can allow for the development of a reduced-order observer. The components can be configured with rule-based fuzzy logic, including the fuzzy logic based roll/pitch angle covariance selector for the Kalman Filter based on roll/pitch dynamic model, the fuzzy logic based covariance selector for reduced-order vehicle longitudinal velocity Kalman Filters, and the fuzzy logic based lateral velocity observer selector between reduced-order Kalman Filters and nonlinear Luenberger observer. The component can be configured with machine learning techniques for wheel speed anomaly detection and wheel speed weighting factor calculation.

By decoupling longitudinal and lateral dynamics, this technical solution can utilize a reduced-order observer, which reduces the difficulty of design, tuning, calibration, firmware implementation, and the computational power of the estimation function. The fuzzy logic selector for the Kalman Filter covariances can increase the estimation accuracy. The fuzzy logic selector for the lateral velocity observer can improve the computational efficiency for the side slip estimation function. The machine learning based technique used for wheel speed anomaly detection and the wheel speed weighting factor determination can facilitate accurately determining the confidence level of each wheel speed, thereby improving the accuracy for the vehicle longitudinal velocity/wheel slip determination.

FIG. 1 depicts a block diagram depicting an example system to determine vehicle dynamics. The system 100 can include at least one data processing system 102 for determining vehicle dynamics. The data processing system 102 can be referred to as or include one or more processors or computing devices. The data processing system 102 can include at least one interface 104, at least one vehicle longitudinal lateral acceleration observer component (“VLLAO”) component 106, at least on vehicle longitudinal dynamics observer (“VLDO”) component 108, at least one vehicle side slip observer (“VSSO”) component 110, at least one vehicle controller 112, or data repository 114. The data processing system 102 can include hardware or a combination of hardware and software, such as communications buses, circuitry, processors, communications interfaces, among others. The data processing system 102, or one or more component thereof, can be programmed using C code, or other programming language. The data processing system 102 can be flashed on one or more chips, chip boards, microprocessors, or other computing device. The data processing system 102 can reside on or within a corresponding vehicle 124 (e.g., a host vehicle). The data repository 114 can store, manage, maintain, or reference one or more data structures, data files, or indexes. For example, the data repository 114 can include or store a confidence index 116, thresholds 118, functions 120, or models 122. The confidence index can refer to a fuzzy logic based covariance index used to determine a confidence index associated with a component of the data processing system 102, such as the VLLAO component 106, or the VLDO component 108. the thresholds 118 can be used by the data processing system 102 in comparison with a lumped confidence index to select an observer to determine or estimate a side slip. The functions 120 can include one or more rules, techniques, programs, or scripts used to perform one or more process of the components of the data processing system 102. The model 122 can refer to or include a machine learning model used, for example, to determine a wheel speed of the vehicle 124.

Each of the components of the data processing system 102 can be implemented using hardware or a combination of software and hardware. Each component of the data processing system 102 can include logical circuitry (e.g., a central processing unit or CPU) that responses to and processes instructions fetched from a memory unit (e.g., memory 715 or storage device 725). Each component of the data processing system 102 can include or use a microprocessor or a multi-core processor. A multi-core processor can include two or more processing units on a single computing component. Each component of the data processing system 102 can be based on any of these processors, or any other processor capable of operating as described herein. Each processor can utilize instruction level parallelism, thread level parallelism, different levels of cache, etc. For example, the data processing system 102 can include at least one logic device such as a computing device or server having at least one processor to communicate via a network.

The components and elements of the data processing system 102 can be separate components, a single component, or part of the data processing system 102. For example, the interface 104, VLLAO component 106, VLDO component 108, VSSO component 110, (and the other elements of the data processing system 102) can include combinations of hardware and software, such as one or more processors configured to initiate stop commands, initiate motion commands, and transmit or receive timing data, for example.

One or more component of the data processing system 102 can be hosted on or within a vehicle 124. One or more components of the data processing system 102 can reside outside or remote from the vehicle 124, and be in communication with the vehicle for at least a certain time period. For example, portions of data illustrated on the data repository 114 can reside on a remote server, such as in a cloud of servers, that maintains the machine learning model 122 or confidence index 116, and can be accessed by the data processing system 102 (e.g., through a network) at various times (e.g., every 12 hours or 24 hours during an update process). The components of the data processing system 102 can be connected or communicatively coupled to one another. The connection between the various components of the data processing system 102 can be wired or wireless, or any combination thereof. Counterpart systems or components can be hosted on other vehicles to enable communication or coordination between vehicles.

The vehicle 124 can communicate using a network, which can include computer networks such as the internet, local, wide, near field communication, metro or other area networks, as well as satellite networks or other computer networks such as voice or data mobile phone communications networks, and combinations thereof. The network can include or constitute an inter-vehicle communications network, e.g., a subset of components including the data processing system 102 and components thereof for inter-vehicle data transfer. The network can include a point-to-point network, broadcast network, telecommunications network, asynchronous transfer mode network, synchronous optical network, or a synchronous digital hierarchy network, for example. The network can include at least one wireless link such as an infrared channel or satellite band. The topology of the network can include a bus, star, or ring network topology. The network can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

The system 100 can include or interface with one or more vehicles 124. The vehicle 124 can refer to any type of vehicle or automobile such as cars, trucks, vans, sports utility vehicles, motorcycles, self-driving vehicle, or driver assist vehicle. The vehicle 124 can be an electric vehicle, gas power vehicle, hybrid vehicle, or other type of vehicle. The vehicle 124 can include an onboard computing unit. The onboard computing unit can include one or more of hardware, software or firmware. The onboard computing unit can include digital components or circuitry, including, for example, one or more component depicted in FIG. 7.

The onboard computing unit can include or interface with, for example, an electronic control unit (“ECU”) of the vehicle 124 to provide drive-by-wire functionality. The onboard computing unit can include or be referred to as an automotive computer, and can include a processor or microcontroller, memory, embedded software, inputs/outputs and communication link(s). An ECU involves hardware and software to perform the functions expected from that particular module. For example, types of ECU include Electronic/engine Control Module (ECM), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), control unit, or control module. Other examples include domain control unit (DCU), Electric Power Steering Control Unit (PSCU), Human-machine interface (HMI), Telematic control unit (TCU), Speed control unit (SCU), Battery management system (BMS). For example, the onboard computing unit of the vehicle 124 can query one or more component or module of vehicle 124 to determine a status of the vehicle 124, which can include, for example, a location or GPS position of the vehicle, speed of the vehicle, acceleration of the vehicle, turn angle of the vehicle, orientation of the vehicle, throttle of the vehicle, brake status or brake amount, or other information.

The vehicle 124 can include or interface with one or more sensors 126. The sensors 126 can be coupled to or associated with a vehicle 124. The sensors 126 can provide information to the data processing system 102. The sensors 126 can be part of the vehicle 124, or remote from the vehicle 124. Sensors 126 can include, for example, a 6-DOF inertia measurement unit, wheel speed sensors, tire pressure sensors, or steering angle sensor. Sensors 126 of the vehicle 124 can include accelerometers, gyroscopes, weight sensors, or proximity sensors, that can collect, detect or determine vehicle dynamics information such as orientation data, velocity, or weight. The IMU sensor can be an electronic device that measures and reports a vehicle's specific force, angular rate, and sometimes the orientation of the body, using a combination of accelerometers, gyroscopes, or magnetometers.

The one or more vehicle 124 can include sensors that are designed, constructed, configured or operational to detect vehicle dynamics information. Sensors 126 can include sensors that detect, for example, an automobile layout, vehicle powertrain information, braking system information, steering information, suspension information, and wheel and tire information. The onboard computing unit or sensors can detect or identify vehicle dynamics information based on aerodynamics information such as drag coefficient, aerodynamics, center of pressure, downforce, ground effect in the vehicle. The onboard computing unit or sensors 126 can detect or identify vehicle dynamics information related to the geometry of the vehicle, such as steering geometry, axle track, camber angle, caster angle, roll center, scrub radius, steering ratio, toe, or wheelbase. The onboard computing unit or sensors can detect or identify vehicle dynamics information related to mass of the vehicle, such as center of mass, moment of inertia, roll moment, sprung mass, unsprung mass, or weight distribution. The onboard computing unit or sensors can detect or identify vehicle dynamics information related to motion of the vehicle, such as body flex, body roll, bump steer, directional stability, critical speed, noise, vibration, harshness, pitch, ride quality, roll, speed wobble, understeer, oversteer, lift-off oversteer, fishtailing, weight transfer, load transfer, yah. The onboard computing unit or sensors can detect or identify vehicle dynamics information related to tire information, such as camber thrust, circle of forces, contact patch, cornering force, ground pressure, pneumatic trail, radial force variation, relaxation length, rolling assistance, self-aligning torque, slip angle, slip, steering ratio, tire load sensitivity. The onboard computing unit or sensors can detect or identify vehicle dynamics information related to the road or surface of the parking zone, such as banked turn, cross slope, drainage gradient, cant, superelevation, road slipperiness, split friction, surface roughness, or texture. The onboard computing unit can retrieve vehicle dynamics information stored in memory of the vehicle 124.

The data processing system 102 can include an interface 104. The interface 104 can be designed, constructed and operational to receive information from one or more device, sensor, or network. The interface 104 can communicate with one or more device, sensor or network. The interface 104 can facilitate communications among or between components of the data processing system 102. The interface 104 can include or provide one or more of a hardware interface, network interface, application programming interface, user interface, graphical user interface. The interface 104 can format data from one format to another in order to facilitate communications between the data processing system 102 and remote systems, or between components of the data processing system 102.

The interface 104 can receive data from one or more sensors 126 of the vehicle 124. The interface 104 can receive data such as wheel speed data, steering angle data, tire pressure data, 6-DOF data from an IMU, velocity information, or other information that facilitates determining vehicle dynamics. The interface 104 can receive the information using one or more techniques. The interface 104 can receive a data stream containing sensor information. The interface 104 can poll or ping the sensors 126 to obtain the sensor data For example, the interface 104 can transmit a request to a sensor 126 for the sensor data, or fetch the sensor data from one or more of the sensors 126. The sensors 126 can push sensor data to the interface 104. The interface 104 can periodically request or obtain sensor data. The interface 104 can request or obtain the sensor data based on a predetermine time interval such as, for example, every second, quarter of a second, tenth of a second, hundredth of a second, thousandth of a second, 2 seconds, 3 seconds, 4 seconds, 5 seconds or other time interval that facilitates determining vehicle dynamics.

The interface 104 can access data from data repository 114. The interface 104 can store data in data repository 114. The interface 104 can obtain sensor data and store the sensor data in the data repository 114 for further processing. The interface 104 can perform a lookup in the data repository to identify data or values, and update the data or values in the data repository 114. For example, the interface 104 can update the confidence index 116, thresholds 118, functions 120, or model 122 by obtaining updated versions of the data structures of data files via an external electronic resource, such as a server.

The data processing system 102 can include a VLLAO component 106 designed, constructed, and operational to receive 6-DOF data from an IMU. The VLLAO component 106 can receive the data from a sensors 126 of the vehicle 124. The 6-DOF data can include, for example, X, Y, and Z acceleration information and X, Y, and Z angular rate information. The VLLAO component 106 can identify or otherwise obtain data for a current time interval. The 6-DOF IMU sensor data can be for a current time interval, such as a most recent sensor measurement by sensors 126. The VLLAO component 106 can be synchronized by a master clock or controller, such as a clock maintained by vehicle controller 112. The VLLAO component 106 can identify the beginning of a time interval and obtain sensor data for the time interval. The VLLAO component 106 can receive sensor data along with time stamps corresponding to measurements of the sensor data. For example, the IMU sensor can make a measurement and associate the value or data with a time stamp corresponding to when the measurement was taken. The VLLAO component 106 can receive the sensor data along with the time stamps.

The VLLAO component 106 can obtain additional information used to determine one or more values associated with vehicle dynamics. For example, the VLLAO component 106 can obtain X, Y, Z acceleration information, a longitudinal velocity estimate for a previous time interval (e.g., a previous longitudinal velocity stored in data repository 114), and an X, Y, Z angle rate for a current time interval. The VLLAO component 106 can receive, for the current time interval, data from the inertia measurement unit comprising acceleration among an x-axis, y-axis and a z-axis, and angular rate among the x-axis, y-axis, and the z-axis.

The VLLAO component 106 can determine a roll angle for the vehicle 124 for the current time interval and a pitch angle for the vehicle 124 for the current time interval based on the data and the previous longitudinal velocity for the previous time interval. The VLLAO component 106 can determine the roll angle for the vehicle 124 for the current time interval and the pitch angle for the vehicle 124 for the current time interval based on an angles kinematic estimation function and a Kalman filter. The VLLAO component 106 can determine a lateral acceleration of the vehicle 124 for the current time interval, a longitudinal acceleration of the vehicle 124 for the current time interval, and a confidence index for the VLLO component 106 for the current time interval based on the data from the IMU, the roll angle, and the pitch angle. The longitudinal acceleration and the lateral acceleration can be at the center-of-gravity of the vehicle 124. The VLLAO component 106 can determine the confidence index for the VLLO component for the current time interval via a fuzzy logic based noise covariance adjustment.

The VLLAO component 106 can be configured to perform the operation depicted in FIG. 3. FIG. 3 depicts a flow diagram depicting an example operation 300 of determining vehicle dynamics, in accordance with an implementation. As illustrated in FIG. 3, the VLLAO component 106 can be configured with the following functions: the roll and pitch angle kinematic estimation function (308), the roll and pitch angle Kalman Filter (including the dynamic model and the fuzzy logic based covariance adjustment) (312), and the roll and pitch angle estimation confidence index (CI_{VLLAO}) determination (314).

The VLLAO component 106 can receive the X, Y, Z acceleration information at 302. The VLLAO component 106 can receive the X, Y, Z acceleration information from an IMU sensor of the vehicle 124. The VLLAO component 106 can receive longitudinal velocity estimation at 304. The VLLAO component 106 can receive the longitudinal velocity estimate for the current time interval or time step from another component of the data processing system 102, such as the VLDO component 108. The longitudinal velocity estimation can be from an immediately previous time interval. The longitudinal velocity estimation can be a running estimate or ongoing estimate. The longitudinal velocity estimate can be an estimate for a time interval that is less than 1 second from the current time interval, less than one-tenth of a second, one-hundredth of a second or other time interval. The longitudinal velocity estimate can be an average velocity of one or more previous time interval, a weighted average of one or more previous time intervals. The longitudinal velocity estimate can be a coarse estimate from a sensor 126 of the vehicle, such as a speedometer of the vehicle 126, or from another component of data processing system 102. The VLLAO component 106 can receive Z angle rate information from the IMU sensor at block 306.

At 308, the VLLAO component 106 can execute a process at time step k for the roll α(k)_{K} and pitch β(k)_{K} angles kinematic estimation function as follows:

$$\{ \begin{matrix}{α ( k )}_{K} = {sin}^{- 1} ( \frac{{A}_{y} ( k )}{\sqrt{{( {ω}_{z} ( k ) ( k ) )}^{2} + {g}^{2}}} ) - {tan}^{- 1} ( \frac{{ω}_{Z} ( k ) }{g} ) \\ {β ( k )}_{K} = {cos}^{- 1} ( \frac{{ω}_{z} ( k ) sin ( α ( k ) ) - {A}_{z} ( k )}{g cos ( α ( k ) )} ) \cdot sign ( {\sum }_{i = {i}_{0}}^{k - 1} \dot{β} ( i ) )\end{matrix}$$

Where A_{y}(k) and A_{z}(k) are accelerometer (6-DOF IMU) readings for acceleration in Y and Z directions in a standardized vehicle frame (e.g., an ISO vehicle frame) at time step k, ω_{z}(k), \dot{β}(k) are the vehicle yaw and pitch rate reading from the 6-DOF IMU, and [symbol] is the estimated vehicle longitudinal velocity, all at time step k. The function can be stored in function data structure 120 in data repository 114.

At 310, the VLLAO component 106 can receive the X, Y angle rate from the IMU sensor for the current time step or time interval. The VLLAO component 106 can apply a Kalman filter to the roll and pitch angles. At 314, the VLLAO component 106 can determine the roll and pitch angle dynamic state space model as follows:

α(k+1)_{D}=α(k)_{D}+Tₛωₓ(k)+w_{α}(k)

β(k+1)_{D}=β(k)_{D}+Tₛω_{y}(k)+w_{β}(k)

where the α, β, ωₓ and ω_{y} are the roll angle, pitch angle, roll angle rate, and pitch angle rate, respectively, and ω_{α} and ω_{β} are the noises from the 6-DOF IMU sensor 126 (e.g., a gyroscope). The VLLAO component 106 can determine the measurement results based on the kinematic estimation of roll and pitch angle as follows:

Y_{α}(k)=α(k)_{K}+n_{α}(k)

Y_{β}(k)=β(k)_{K}+n_{β}(k)

Where the n_{α} and n_{β} can be denoted as measurement noises which cover the model uncertainty of kinematic model. The noise covariance n_{α} and n_{β} can be adjusted by a Fuzzy Logic Rule-Based adjustment technique, an example of which is illustrated in Table 1 and can be based on the acceleration and angle rate range during operation.

The VLLAO component 106 can be configured with a Kalman filter the estimated roll α(k+1)_{KF} and pitch β(k+1)_{KF} angles as follows:

$$( ) = {Ψ}_{K F} [ \hat{α} , {α ( k )}_{K} , {T}_{s} {ω}_{x} ( k ) , 1 , 1 , 1 , {w}_{α} ( k ) , {n}_{α} ( k ) , {σ}_{α} ( k ) ]$$

$$( ) = {Ψ}_{K F} [ , {β ( k )}_{K} , {T}_{s} {ω}_{y} ( k ) , 1 , 1 , 1 , {w}_{β} ( k ) , {n}_{β} ( k ) , {σ}_{β} ( k ) ]$$

The Kalman Filter of the VLLAO component 106 can take the Kalman Filter estimated state [symbol] , state matrixes (A(k), B(k), C(k)), input u(k), measurement y(k), process and measurement noise covariances (w(k), n(k)), and the Kalman Filter estimated error covariance σ(k) at time step k as inputs and then estimate the states x(k+1) and error covariance σ(k+1) at the next time step.

At time step k, the VLLAO component 106 can determine the estimation states (xₑₛₜᵢₘₐₜₑ, yₑₛₜᵢₘₐₜₑ) as,

$$\{ \begin{matrix}{x}_{estimate} = A ( k ) + B ( k ) u ( k ) \\ {y}_{estimate} = C ( k ) \end{matrix}$$

The VLLAO component can update the error covariance σ as,

σ=A(k)σ(k)C⁻¹(k)+w(k)

The VLLAO component 106 can determine the Kalman Filter feedback gain as,

K_{KF}=σC⁻¹(k)[(C(σC⁻¹(k))⁻¹+n(k)]

The VLLAO component 106 can determine the Kalman Filter estimated state for the next time step x(k+1) as,

x( [symbol] )=xₑₛₜᵢₘₐₜₑ+K_{KF}(y(k)yₑₛₜᵢₘₐₜₑ)

The VLLAO component 106 can update the Kalman Filter error covariance for the next time step x(k+1) as,

σ(k+1)=(1−K_{KF}C(k))σ(k)

The VLLAO component 106 can use the updated x(k+1) and x( [symbol] ), along with state matrixes (A(k+1), B(k+1), C(k+1)), input u(k+1), measurement y(k+1), process and measurement noise covariances (w(k+1), n(k+1)) to estimate x( [symbol] ) and x(k+2) in this same recursive manner. For example, at block 316 the VLLAO component 106 can receive estimated roll and pitch angles, and provide the values as feedback into block 314 which can apply roll and pitch angle dynamic estimation and apply Kalman Filtering. The outputs of blocks 308, 312 and 314 can be provided to block 316 to determine the estimated roll and pitch angle.

Thus, the VLLAO component 106 an apply or execute a Kalman Filter for the roll and pitch angle as follows:

$$( \begin{matrix}x \\ σ\end{matrix} ) = {Ψ}_{K F} , y ( k ) , u ( k ) , A ( k ) , B ( k ) , C ( k ) , w ( k ) , n ( k ) , σ ( k ) ]$$

At 318, the VLLAO component 106 can determine the lateral and longitudinal accelerations and confidence index. The VLLAO component 106 can receive the estimated roll and pitch angles from block 316 as well as 6-DOF sensor data (from acceleration data and angular rate data) from the IMU from block 302. The VLLAO component 106 can determine the roll and pitch angle estimation confidence index (CI_{VLLAO}) at 318. The VLLAO component 106 can determine C_{VLLAO} based on Table 1. Table 1 can be referred to an index or lookup table and can be stored in confidence index data structure or data file 116 in data repository 114.

TABLE 1
Fuzzy Logic Based Noise Covariance And
Confidence Index Adjustment for VLLAO

| | Acceleration | Angular Rate | Noise | Confidence |
|---|---|---|---|---|
| CASE | Level | Level | Covariance | Index |
| 1 | High | High | n_{H} | CI_{VLLAO}_{_{H}} |
| 2 | High | Low | n_{M} | CI_{VLLAO}_{_{M}} |
| | Low | High | | |
| 3 | Low | Low | n_{L} | CI_{VLLAO}_{_{L}} |

Table 1 illustrates a data structure or index or lookup table for Confidence Index. Table 1 includes Cases, Acceleration levels, angular rate levels, noise covariances, and confidence indexes. The acceleration level can include values such as low, medium, or high. The acceleration level can include other indications of acceleration, such as numerical indications, letter grades (e.g., A, B, C), alphanumeric indications, or symbols. The angular rate level can include values such as low, medium, or high. The angular rate level can include other indications of angular rate, such as numerical indications, letter grades (e.g., A, B, C), alphanumeric indications, or symbols.

Table 1 can include multiple cases, such as cases 1, 2 and 3. Case 1 can correspond to an acceleration level of high, angular rate of high, noise covariance n_{H} and confidence index CI_{VLLAO}_{_{H}}. Case 2 can include a high acceleration level with a low angular rate level, noise covariance nₘ and confidence index CI_{VLLAO}_{_{M}}. Case 2 can also include a low acceleration level with a high angular rate, noise covariance nₘ and confidence index CI_{VLLAO}_{_{M}}. Case 3 can include a low acceleration level, low angular rate, noise covariance n_{L} and confidence index CI_{VLLAO} _{_{L}}.

The VLLAO component 106 can determine the acceleration level and the angular rate level using, for example, the following fuzzy logic.

$$\{ \begin{matrix}Acceleration Level = High , if max ( {A}_{x} , {A}_{y} , {A}_{z} ) > {A}_{m i n} \\ Acceleration Level = Low , if max ( {A}_{x} , {A}_{y} , {A}_{z} ) \leq {A}_{m i n} \\ Angular Rate Level = High , if max ( {ω}_{x} , {ω}_{y} , {ω}_{z} ) > {ω}_{m i n} \\ Angular Rate Level = Low , if max ( {ω}_{x} , {ω}_{y} , {ω}_{z} ) \leq {ω}_{m i n}\end{matrix}$$

Where (Aₓ, A_{y}, A_{z}, ωₓ, ω_{y}, ω_{z}) are acceleration and angular rate reading from 6-DOF IMU sensor 126, (Aₘᵢₙ, ωₘᵢₙ) are user-defined threshold, (n_{H},n_{M},n_{L}) are user-defined three levels of noise covariance which can follow the design rule n_{H}>n_{M}>n_{L}, and similarly (CI_{VLLAO}_{_{H}}, CI_{VLLAO}_{_{M}}, CI_{VLLAO}_{_{L}}) are user-defined three levels of confidence index which follows the design rule CI_{VLLAO}_{_{H}}<CI_{VLLAO}_{_{M}}<CI_{VLLAO}_{_{L}}.

At 318, the VLLAO component 106 can determine the estimated longitudinal and lateral acceleration at the COG of the vehicle 124 as follows:

$$\{ \begin{matrix}{a}_{x} ( k ) = {A}_{x} ( k ) - g sin ( {\hat{α} ( k )}_{K F} ) \\ {a}_{y} ( k ) = {A}_{y} ( k ) - g cos ( {\hat{β} ( k )}_{K F} )\end{matrix}$$

Thus, at 318, the VLLAO component 106 can determine the lateral and longitudinal accelerations, as well as the confidence index from the fuzzy logic rule based technique from Table 1.

The data processing system 102 can include a VLDO component 108 designed, constructed and operational to receive wheel speed sensor data for each wheel of the vehicle 124 (e.g., four wheels), tire pressure sensor data for each wheel of the vehicle 124 (e.g., four tires), and steering angle sensor data. The VLDO component 106 can identify the previous longitudinal velocity for the previous time interval or the estimated longitudinal velocity from a previous iteration. The VLDO component 108 can identify the lateral acceleration and the longitudinal acceleration for the current time interval determined by the VLLAO component 106. The VLDO component 108 can determine the wheel speed via a machine learning based anomaly detection function and the wheel speed sensor data for each wheel of the vehicle 124. The VLDO component 108 can determine a longitudinal velocity for the current time interval and a confidence index for the VLDO component 108 based on the wheel speed sensor data for each wheel of the vehicle 124, the tire pressure sensor data for each wheel of the vehicle 124, the steering angle sensor data, the longitudinal velocity for the previous time interval, and the lateral acceleration and the longitudinal acceleration for the current time interval. The VLDO component 108 can determine the confidence index of the VLDO component 108 via a fuzzy logic based noise covariance adjustment.

The VLDO component 108 can be configured to perform the operation depicted in FIG. 4. FIG. 4 depicts a flow diagram depicting an example operation 400 of determining vehicle dynamics, in accordance with an implementation. As illustrated in FIG. 4, the VLDO component 108 can perform determine the wheel speed estimate using a machine learning enhanced anomaly detection technique. The VLDO component 108 can determine the longitudinal velocity estimate confidence index (C_{VLDO}). The VLDO component 108 can determine the vehicle longitudinal velocity Kalman Kilter with fuzzy logic based covariance adjustment.

The VLDO component 108 can receive the wheel speed sensor data 402 from a wheel speed sensor, tire pressure data 404 from a tire pressure sensor, and steering angle data 406 from a steering angle sensor. The VLDO component 108 can receive the wheel speed sensor data 402 for each wheel of the vehicle 124. The VLDO component 108 can receive the tire pressure data 404 for each tire of the vehicle 124. The VLDO component 108 can receive or identify the estimated longitudinal velocity 408 from the VLLAO component 106 or from a previous time interval or via a recursive process. The VLDO component 108 can receive the estimated X, Y accelerations 410 (e.g., lateral acceleration and longitudinal acceleration from block 318 depicted in FIG. 3).

At 414, the VLDO component 108 can perform wheel speed estimation via a machine learning enhanced anomaly detection function or technique. This technique can use the individual wheel speeds, the estimated longitudinal vehicle velocity from last time step (e.g., previous longitudinal velocity), and the individual tire pressures. The VLDO component 108 can output at block 414 the optimal estimated wheel speed V_{wheel} (k) and the probability for individual wheels (P_{FL}, P_{FR}, P_{RL}, P_{RR}).

The VLDO component 108 can be configured with a machine learning enhanced wheel speed anomaly detection technique to determine the wheel speed of the vehicle 124. This technique can be based on a multi-dimensional Gaussian distribution. The VLDO component 108, using this technique, can determine the optimal wheel speed as the measurement input for a vehicle speed Kalman Filter. The VLDO component 108 can detect the unreliable wheel speed data based on a distribution of features of wheels in training sets. For example, the features of this machine learning model can include the velocity, acceleration, and tire speed of vehicle wheels.

$$X = ( \begin{matrix}{V}_{w} - {V}_{x} \\ {a}_{w} - {a}_{x} \\ {P}_{w}\end{matrix} )$$

The Vₓ [symbol] and αₓ can be the estimated longitudinal vehicle velocities and acceleration at the previous time step k−1. The VLDO component 108 can determine the wheel angle rate from a wheel speed sensor. The VLDO component 108 can determine the velocity of each wheel (V_{W}) as follows:

$$\begin{matrix}{v}_{FL} = {ω}_{FL} R cos ( δ ) - α \frac{L}{2} \\ {v}_{FR} = {ω}_{FR} R cos ( δ ) + α \frac{L}{2} \\ {v}_{RL} = {ω}_{RL} R - α \frac{L}{2} \\ {v}_{RR} = {ω}_{RR} R + α \frac{L}{2}\end{matrix}$$

Where ω, is wheel angular velocity, R is the radius of wheels, a is yaw rate measured by the 6-DOF IMU, and L is wheel track length. The VLDO component 108 can determine the acceleration of each wheel (α_{W}) by numerical differentiation with a low pass filter having a filter coefficient N as follows:

$${a}_{w} ( k ) = \frac{{a}_{w} ( k - 1 ) + N [ v ( k ) - v ( k - 1 ) ]}{1 + {T}_{s} N}$$

The VLDO component 108 can obtain the tire pressure of each wheel (P_{wheel}) from the tire pressure sensor.

The training process can be performed by the data processing system 102 or other computing device in an offline manner. Offline can refer to prior to the system going online or a real-time activity. The offline training can use one or more component of system 100, or one or more different components, such as a high-accuracy GPS sensor that may not be included as part of system 100 or vehicle 124. The training process can be performed by an administrator of the data processing system 102 during a setup or configuration phase. The training process can include measuring longitudinal vehicle velocities (Vₓ) directly using a high-accuracy GPS to generate a training data set. The training data set can be stored in model database 122 in data repository 114. In the training data set, if a Root Mean Square Error (RMSE) of the Vₓ and V_{w} is larger than certain threshold ζ, it can be labeled as being an anomalous detection. The VLDO component 108 can retrieve the threshold from threshold data structure 118 in data repository 114.

Given,

$$P ( x , μ , \sum ) = \frac{1}{{( 2 π )}^{\frac{n}{2}} {\vert \sum \vert}^{\frac{1}{2}}} exp ( - \frac{1}{2} {( x - μ )}^{T} {\sum }^{- 1} ( x - μ ) )$$

Where the

$$μ = \frac{1}{m} {\sum }_{i = 1}^{m} {x}^{i} , {\sum }_{ }^{ } = \frac{1}{m} {\sum }_{i = 1}^{m} ( {x}^{i} - μ ) {( {x}^{1} - μ )}^{T} ,$$

n is numbers of features, and m is the numbers of train samples.

By offline training, a suitable parameter, ε, can be find. Then, the ε can be used by the data processing system 102 as a decision boundary.

In an online mode (e.g., real-time operation of vehicle 124), if the VLDO component 108 determines the anomaly detection probability of a wheel, P (x)<ε, the VLDO component 108 can label the wheel as an anomaly. The VLDO component 108 can reject the data of the wheel by directly setting the P(x) of this wheel to 0.

The VLDO component 108 can update the weighted wheel speed as follows:

V_{wheel}(k)=ΣᵢWᵢVᵢ(k),i=FL,FR,RL,RR

The VLDO component 108 can determine the weight factor of each wheel (Wᵢ) as

$${W}_{i} = \frac{1}{{\sum }_{i} {P}_{i} ( x )} {P}_{i} ( x ) .$$

Thus, VLDO component 108 can determine the optimal wheel speed measurement as the optimal wheel speed obtained at block 414 via the offline machine learning technique and the online updating. The state space equation of the measurement can be:

Yᵥ_{_{X}}(k)=V_{wheel}(k)n_{wheel}(k)

Where n_{wheel}(k) is the measurement noise.

Thus, VLDO component 108 can determine the optimal wheel speed measurement as the optimal wheel speed obtained at block 414 via the offline machine learning technique and the online updating. The state space equation of the measurement can be:

Yᵥ_{_{X}}(k)=V_{wheel}(k)n_{wheel}(k)

Where n_{wheel}(k) is the measurement noise.

Based on the outputs from machine learning enhanced wheel speed anomaly detection technique at block 414, the VLDO component 108 can determine the CI_{VLDO} at block 416 using the fuzzy logic depicted in Table 2. At block 416, the VLDO component can adjust the value of the noise covariance by the fuzzy logic rule-based technique illustrated in Table 2, which can represent the accuracy confidence of the optimal wheel speed.

TABLE 2
Fuzzy Logic Based Noise Covariance And
Confidence Index Adjustment (VLDO)

| CASE | Wheel Speed Level | Noise Covariance | Confidence Index |
|---|---|---|---|
| 1 | High | n_{wheel}_{_{H}} | CI_{VLDO}_{_{H}} |
| 2 | Mid | n_{wheel}_{_{M}} | CI_{VLDO}_{_{M}} |
| 3 | Low | n_{wheel}_{_{L}} | CI_{VLDO}_{_{L}} |

Table 2 can be referred to an index or lookup table and can be stored in confidence index data structure or data file 116 in data repository 114. Table 2 can include multiple cases. For each case, Table 2 can include a wheel sped level, noise covariance and confidence index of the VLDO component 108. The wheel speed level can be low, medium or high. The wheel speed level can include any type of indication or value, such as numerical values, letter grades (e.g., A, B, C), alphanumeric values, or symbols. The VLDO component 108 can determine the wheel sped level at block 416 based on the following fuzzy logic as follows:

$$\{ \begin{matrix}Wheel Speed Level = High , & if ϕ ∈ [ 0 , {ϕ}_{1} ) \\ Wheel Speed Level = Mid , & if ϕ ∈ [ {ϕ}_{1} , {ϕ}_{2} ) \\ Wheel Speed Level = Low , & if ϕ ∈ [ {ϕ}_{2} , 1 )\end{matrix}$$

Where,

$$\{ \begin{matrix}ϕ = min ( {P}_{FL} , {P}_{FR} , {P}_{RL} , {P}_{RR} \\ 0 < {ϕ}_{1} < {ϕ}_{2} < 1\end{matrix}$$

The (n_{wheel}_{_{H}}, n_{wheel}_{_{M}}, n_{wheel}_{_{L}} d can be user-defined three levels of noise covariance which follows the design rule n_{wheel}_{_{H}}>n_{wheel}_{_{M}}>n_{wheel}_{_{L}}, and similarly (CI_{VLDO}_{_{H}}, CI_{VLDO}_{_{M}}, C_{VLDO}_{_{L}}) are user-defined three levels of confidence index which follows the design rule CI_{VLDO}_{_{H}}<CI_{VLDO}_{_{M}}<CI_{VLDO}_{_{L}}. The noise covariances and confidence indexes can be stored in data repository 114.

The VLDO component 108 can receive the estimated X, Y accelerations at block 412. At block 418, the VLDO component 108 can apply the following longitudinal velocity dynamic model to determine the longitudinal velocity as follows:

Vₓ(k+1)=Vₓ(k)+Tₛαₓ(k)+w_{V}_{ₓ}(k)

Where Vₓ and αₓ can be longitudinal velocity and acceleration at the COG of the vehicle 124, and w_{V}_{ₓ}(k) can be used to represent the unknown process noise acting on the longitudinal dynamic model.

At 418, the VLDO component 108 can apply a Kalman Filter for the estimated velocity Vₓ( [symbol] )_{KF} as follows:

$$( \begin{matrix}{V}_{x} {KF}_{} \\ {σ}_{Vx} ( k + 1 )\end{matrix} ) = {Ψ}_{KF} [ {KF}_{} , {V}_{wheel} ( k ) , {T}_{s} {a}_{x} ( k ) , 1 , 1 , 1 , {w}_{{V}_{x}} ( k ) , {n}_{wheel} ( k ) , {σ}_{{V}_{x}} ( k ) ]$$

At 420, the VLDO component 108 can receive the longitudinal velocity and confidence index from blocks 416 and 418. At 420, the VLDO component 108 can feed the longitudinal velocity back into block 418 for a recursive process to determine the optimal velocity.

The data processing system 102 can include a VSSO component 110 designed, constructed and operational to select one of a reduced-order nonlinear Luenberger observer technique or a reduced-order Kalman filter technique based on the confidence index of the VLLAO component 106 and the confidence index of the VLDO component 108. The VSSO component 110 can determine, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval. The VSSO component 110 can provide the lateral velocity and the sideslip angle for the current time interval to a vehicle controller 112 to cause the vehicle controller 112 to control movement of the vehicle.

The VSSO component 110 can select one of the reduced-order nonlinear Luenberger observer technique or reduced-order Kalman filter technique based on a lumped confidence index. The VSSO component 110 can determine the lumped confidence index based on the confidence index of the VLLAO component and the confidence index of the VLDO component. The VSSO component 110 can select the reduced-order nonlinear Luenberger observer technique responsive to the lumped confidence index being greater than a threshold, or select the reduced-order Kalman filter technique responsive to the lumped confidence index being less than or equal to the threshold. The VSSO component 110 can retrieve the threshold from the threshold data structure 118 stored in data repository 114.

The VSSO component 110 can be configured to perform the operation depicted in FIG. 5. FIG. 5 depicts a flow diagram depicting an example operation 500 of the VSSO component 110, in accordance with an implementation. As illustrated in FIG. 5, the VSSO component 110 can provide a reduced-order nonlinear Luenberger observer, a reduced-order Kalman Filter, and a fuzzy logic based observer selector.

The VSSO component 110 can receive the longitudinal velocity confidence index 502 from the VLDO component 108. The VSSO component 110 can receive the pitch and roll confidence index 504 from the VLLAO component 106. At block 506, the VSSO component 110 can use a fuzzy logic rule-based observer selection technique to select an observer to use at block 514. To select the observer, the VSSO component 110 can receive CI_{VLLAO} and CI_{VLDO}) as inputs, determine a lumped confidence index, and then make a corresponding selection between the reduced-order nonlinear Luenberger observer and reduced-order Kalman Filter based on the lumped confidence index being greater than or less than or equal to a threshold.

The VSSO component 110 can determine the lumped confidence index CI_{ξ} as follows:

CI_{ξ}=min(CI_{VLLAO},CI_{VLDO})

The VSSO component 110 can determine or identify a minimum lumped confidence index CI_{ξ}_{ₘᵢₙ} threshold for the selection decision. The VSSO component 110 can use the following selection logic:

$$select \{ \begin{matrix}reduced \text{-} order nonlinear Luenberger observer , & if {CI}_{ξ} > {{CI}_{ξ}}_{min} \\ reduced \text{-} order Kalman Filter , & if {CI}_{ξ} \leq {{CI}_{ξ}}_{min}\end{matrix}$$

Thus, the VSSO component 110 can select one of the reduced-order Luenberger observer or reduced-order Kalman filter based on the lumped confidence index.

At block 514, the VSSO component 110 can execute the selected observer to determine a longitudinal velocity. The VSSO component 110 can receive the longitudinal velocity estimation at 508, the estimated X, Y accelerations at 510, and the X, Y angle rates 512. For example, the lateral velocity observer can be based on a linear kinematic single-track model as follows:

$$\frac{d}{dt} ( \begin{matrix}{V}_{x} \\ {V}_{y}\end{matrix} ) = ( \begin{matrix}0 & {ω}_{z} \\ - {ω}_{z} & 0\end{matrix} ) ( \begin{matrix}{V}_{x} \\ {V}_{y}\end{matrix} ) + ( \begin{matrix}1 & 0 \\ 0 & 1\end{matrix} ) ( \begin{matrix}{a}_{x} \\ {a}_{y}\end{matrix} )$$

$$y = ( \begin{matrix}1 & 0\end{matrix} ) ( \begin{matrix}{V}_{x} \\ {V}_{y}\end{matrix} )$$

Using Euler's method, the above state-space model in continues-time domain can be discretized in the following manner:

$$\{ \begin{matrix}{A}_{d} = 1 + {T}_{s} A \\ {B}_{d} = {T}_{s} B \\ {C}_{d} = C\end{matrix}$$

The discretized state-space model can be carried out as:

$$( \begin{matrix}{V}_{x} ( k + 1 ) \\ {V}_{y} ( k + 1 )\end{matrix} ) = ( \begin{matrix}1 & {ω}_{z} ( k ) {T}_{s} \\ - {ω}_{z} ( k ) {T}_{s} & 1\end{matrix} ) ( \begin{matrix}{V}_{x} ( k ) \\ {V}_{y} ( k )\end{matrix} ) + ( \begin{matrix}{T}_{s} & 0 \\ 0 & {T}_{s}\end{matrix} ) ( \begin{matrix}{a}_{x} ( k ) \\ {a}_{y} ( k )\end{matrix} ) + ( \begin{matrix}{w}_{Vx} ( k ) \\ {w}_{Vy} ( k )\end{matrix} )$$

$${Y}_{Vy} ( k ) = ( \begin{matrix}1 & 0\end{matrix} ) ( \begin{matrix}{V}_{x} ( k ) \\ {V}_{y} ( k )\end{matrix} ) + {n}_{Vy} ( k )$$

Since the VSSO component 110 already obtained an accurate Vₓ estimation from the VLDO component 108, the VSSO component 110 can use a reduced-order Luenberger observer for estimating V_{y}.

The VSSO component 110 can establish a nonlinear pole location of zₚ=1−kw²Tₛ, where k is the scaling factor.

For stability purposes, the VSSO component 110 can use a scaling factor that is selected such that

$$k < \frac{1}{{ω}^{2} {T}_{s}}$$

The corresponding nonlinear Luenberger observer gain G can be computed as,

G=(A_{d}_{₂₂}−zₚ)A_{d}_{₁₂}⁻¹=kω

The VSSO component 110 can be configured with the following reduced-order nonlinear Luenberger observer with the nonlinear-pole-placement approach:

V_{y}( [symbol] )_{L}=(1−kω_{z}(k)²Tₛ)V̅_̅{̅y̅}̅(̅k̅)̅_{L}+kω_{z}(k)[Vₓ(k+1)−Vₓ(k)−Tₛαₓ(k)]−ω_{z}(k)TₛVₓ(k)+Tₛα_{y}(k)

The VSSO component 110 can be configured with the reduced-order Kalman Filter using the same reduced-order model in a manner similar to that established for the VLLAO component 106 as follows:

$$( \begin{matrix}{V}_{y} {KF}_{} \\ {σ}_{Vy} ( k + 1 )\end{matrix} ) = {Ψ}_{KF} [ , {V}_{x} ( k ) , ( - {ω}_{z} ( k ) {T}_{s} {V}_{x} ( k ) + {T}_{s} {a}_{y} ( k ) ) , 1 , 1 , 1 , {w}_{Vy} ( k ) , {n}_{Vy} ( k ) , {σ}_{Vy} ( k ) ]$$

The VSSO component 110 can use the Vₓ_{_{KF}} from the VLDO component 106 as the Vₓ in the above function.

Thus, at block 514, the VSSO component 110 can apply one of the Luenberger Observer or Kalman filter, and at block 516 the VSSO component 110 can determine the lateral velocity.

At block 516, the VSSO component 110 can determine the side slip angle φ(k) as follows:

$$φ ( k ) = {tan}^{- 1} ( \frac{{V}_{x} ( k )}{} ) , = fuzzy logic based observer selector ( {L}_{} , )$$

The sideslip angle can refer to the angle between the direction in which a wheel is pointing and the direction in which it is actually traveling (e.g., the angle between the longitudinal velocity vector the vector sum of wheel longitudinal velocity and lateral velocity. This slip angle can result in a force, the cornering force, which can be in the plane of the contact patch and perpendicular to the intersection of the contact patch and the midplane of the wheel. This cornering force increases approximately linearly for the first few degrees of slip angle, then increases non-linearly to a maximum before beginning to decrease.

The data processing system 102 can include a vehicle controller 112 designed, constructed and operational to receive the vehicle dynamics information from one or more component of the data processing system 102. For example, the VSSO component 110 can provide the lateral velocity and side slip angle to the vehicle controller 112. The vehicle controller 112 also obtain information about the longitudinal velocity, accelerations, or other vehicle dynamics information from the VLLAO component 106, VLDO component 108, or sensors 126. The vehicle controller 112 can use the received information to control, maintain, adjust, modify or otherwise control an aspect or characteristic of movement of the vehicle 126.

For example, the vehicle controller 112 can use the lateral velocity and the sideslip angle to maintain an adaptive cruise control functionality of the vehicle 124. The vehicle controller 112 can use the received information to accelerate or decelerate the vehicle 124, or adjust steering of the vehicle 124. For example, if the sideslip angle is increasing, then the vehicle controller 112 can determine to decrease power to the wheels of the vehicle 124 or decelerate the vehicle 124 in order to maintain the sideslip angle or lateral velocity below a threshold. The vehicle controller 112 can reduce or maintain the sideslip angle of the vehicle 124 below a threshold so as to improve aspects of driving, such as minimize the likelihood of the vehicle 124 slipping or losing control, or improving driving experience of a driver or passenger of the vehicle 124. The vehicle controller 112 can determine to automatically adjust the movement of the car based on the vehicle dynamics information received from the VSSO component 110.

The vehicle controller 112 can receive vehicle dynamics information and determine to make adjustments on a periodic bases, such as every second, 2 seconds, 3 seconds, 4 seconds, 5 seconds, one-tenth of a second, one-hundredth of a second, one two-hundredth of a second or any other time interval.

The vehicle controller 112 can also adjust steering of the vehicle to control the sideslip angle or lateral velocity. For example, if the vehicle 124 is an autonomous vehicle or semi-autonomous vehicle in which the vehicle controller 112 is configured to adjust or control steering, the vehicle controller 112 can steer the vehicle 124 in order to control lateral velocity and sideslip angle while keeping the vehicle 124 on the desired travel path (e.g., within an appropriate lane on a road).

FIG. 2 depicts a flow diagram depicting an example operation of a system to determine vehicle dynamics, in accordance with an implementation. Operation 200 can be implemented by one or more component of system 100, including, for example, a data processing system, VLLAO component, VLDO component, or VSSO component. The data processing system can receive IMU data (e.g., sensor data from an IMU of a vehicle). The data can include 6-DOF data, such as X, Y, Z accelerations and X, Y, Z angular rates. The VLLAO component 106 can use the IMU data 202 to determine lateral and longitudinal accelerations, a confidence index of the VLLAO component 106, and estimated roll and pitch angles.

The data processing system can receive tire pressure sensor data 204, steering angle sensor data 206 and wheel speed sensor data 208 from sensors of the vehicle. The VLDO component 108 can process the data 204, 206 and 208 to determine a longitudinal velocity and a confidence index of the VLDO component 108.

The VLLAO component 106 and VLDO component 108 can pass data or parameters back and forth in a feedback loop so as to perform a recursive process to determine a value. For example, an estimated longitudinal velocity can be passed between components 106 and 108.

The VSSO component 110 can receive the lateral and longitudinal accelerations, confidence index of the VLLAO component, estimated roll and pitch angles, longitudinal velocity, and confidence index of the VLDO component 108 to determine a lateral velocity and sideslip angle.

FIG. 6 depicts a method of controller vehicle dynamics, in accordance with an implementation. The method 600 can be performed by one or more system, component, element or function depicted in FIG. 1-5 or 7, including, for example, a data processing system, VLLAO component, VLDO component, VSSO component, or vehicle controller. At 602, the data processing system can identify a previous longitudinal velocity. The previous longitudinal velocity can be for a previous time step, or default longitudinal velocity, or coarse longitudinal velocity determined directly from a sensor of the vehicle.

At 604, the data processing system can receive data from an inertia measurement unit. The data can include 6-DOF data, such as accelerations and angular rates in one or more directions or axes. The data processing system can receive the IMU data for a current time interval or time step.

At 606, the data processing system can determine a roll angle and a pitch angle. The data processing system can determine a roll angle for the vehicle for the current time interval and a pitch angle for the vehicle for the current time interval based on the IMU data and the previous longitudinal velocity for the previous time interval. The data processing system can use one or more techniques depicted in FIG. 3 to determine the roll angle and the pitch angle.

At 608, the data processing system can determine a lateral acceleration and a longitudinal acceleration for the vehicle for the current time interval. The data processing system can determine the lateral acceleration of the vehicle for the current time interval, the longitudinal acceleration of the vehicle for the current time interval, and a confidence index for a VLLO component for the current time interval based on the data from the inertia measurement unit, the roll angle, and the pitch angle.

At 610, the data processing system can receive wheel speed sensor data for each wheel of the vehicle, tire pressure sensor data for each wheel of the vehicle, and steering angle sensor data. The data processing system can receive this data from one or more sensors of the vehicle and for the current time interval.

At 612, the data processing system can determine a longitudinal velocity. The data processing system can determine the longitudinal velocity for the current time interval and a confidence index for the VLDO component based on the wheel speed sensor data for each wheel of the vehicle, the tire pressure sensor data for each wheel of the vehicle, the steering angle sensor data, the longitudinal velocity for the previous time interval, and the lateral acceleration and the longitudinal acceleration for the current time interval. The data processing system can determine the longitudinal velocity using one or more function or technique depicted in FIG. 4.

At 614, the data processing system can select one of a reduced-order nonlinear Luenberger observer technique or a reduced-order Kalman filter technique. The data processing system can select one of a reduced-order nonlinear Luenberger observer technique or a reduced-order Kalman filter technique based on the confidence index of the VLLAO component and the confidence index of the VLDO component.

At 616, the data processing system can determine a lateral velocity and a sideslip angle for the vehicle. The data processing system can determine, via the selected one of the reduced-order nonlinear Luenberger observer technique or the reduced-order Kalman filter technique, the lateral velocity and the sideslip angle of the vehicle for the current time interval based on the longitudinal velocity, the lateral acceleration, and the longitudinal acceleration for the current time interval.

At 618, the data processing system can provide the lateral velocity and the sideslip angle to a vehicle controller. The vehicle controller control movement of the vehicle based on the lateral velocity and sideslip angle. The vehicle controller can determine to keep the same speed, increase the speed, or decrease the speed of the vehicle based on the lateral velocity and sideslip angle. The vehicle controller can determine to adjust steering or keep the same steering angle based on the lateral velocity and sideslip angle.

FIG. 7 is a block diagram of an example computer system 700. The computer system or computing device 700 can include or be used to implement the data processing system 102, or its components such as the data processing system 102. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory. The main memory 715 can also be used for storing confidence indexes, thresholds, functions, models, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the data repository 114.

The computing system 700 may be coupled via the bus 705 to a display 735, such as a liquid crystal display, or active matrix display, for displaying information to a user such as a driver of the vehicle 124. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the data processing system 102, or other component of FIG. 1, as well as part of the vehicle external to the data processing system 102, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., VLLAO component 106 or VSSO component 110) and operations 300, 400 or 500 depicts grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system to control vehicle dynamics, comprising:
a data processing system comprising one or more processors and memory;
a vehicle longitudinal and lateral observer (“VLLO”) component executed by the one or more processors to:
identify, for a previous time interval, a previous longitudinal velocity of a vehicle;
receive, for a current time interval, data from an inertia measurement unit of the vehicle;
determine a roll angle for the vehicle for the current time interval and a pitch angle for the vehicle for the current time interval based on the data and the previous longitudinal velocity for the previous time interval;
determine a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle;
a vehicle longitudinal dynamics observer (“VLDO”) component executed by the one or more processors to:
receive wheel speed sensor data for each of a plurality of wheels of the vehicle, tire pressure sensor data for each of the plurality of wheels of the vehicle, and steering angle sensor data;
identify the previous longitudinal velocity for the previous time interval;
identify the lateral acceleration and the longitudinal acceleration for the current time interval determined by the vehicle longitudinal and lateral observer component;
determine a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval;
a vehicle side slip observer (“VSSO”) component executed by the one or more processors to:
select one of a reduced-order nonlinear Luenberger observer technique or a reduced-order Kalman filter technique based on the confidence index of the VLLAO component and the confidence index of the VLDO component;
determine, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval; and
provide the lateral velocity and the sideslip angle for the current time interval to a vehicle controller to cause the vehicle controller to control movement of the vehicle.

2. The system of claim 1, comprising:
the vehicle controller to use the lateral velocity and the sideslip angle to maintain an adaptive cruise control functionality of the vehicle.

3. The system of claim 1, comprising:
the VLLAO component to receive, for the current time interval, data from the inertia measurement unit comprising acceleration among an x-axis, y-axis and a z-axis, and angular rate among the x-axis, y-axis, and the z-axis.

4. The system of claim 1, comprising:
the VLLAO component to determine the roll angle for the vehicle for the current time interval and the pitch angle for the vehicle for the current time interval based on an angles kinematic estimation function and a Kalman filter.

5. The system of claim 1, comprising:
the VLLAO component to determine the confidence index for the VLLO component for the current time interval via a fuzzy logic based noise covariance adjustment.

6. The system of claim 1, comprising the VLDO component to:
determine a wheel speed via a machine learning based anomaly detection function and the wheel speed sensor data for each of the plurality of wheels of the vehicle; and
determine the confidence index of the VLDO component via a fuzzy logic based noise covariance adjustment.

7. The system of claim 1, comprising the VSSO component to:
determine a lumped confidence index based on the confidence index of the VLLAO component and the confidence index of the VLDO component; and
select the reduced-order nonlinear Luenberger observer technique responsive to the lumped confidence index being greater than a threshold.

8. The system of claim 1, comprising the VSSO component to:
determine a lumped confidence index based on the confidence index of the VLLAO component and the confidence index of the VLDO component; and
select the reduced-order Kalman filter technique responsive to the lumped confidence index being less than or equal to a threshold.

9. A method of controlling vehicle dynamics, comprising:
identifying, by a vehicle longitudinal and lateral observer (“VLLO”) component executed by one or more processors for a previous time interval, a previous longitudinal velocity of a vehicle;
receiving, by the VLLO component for a current time interval, data from an inertia measurement unit of the vehicle;
determining, by the VLLO component, a roll angle for the vehicle for the current time interval and a pitch angle for the vehicle for the current time interval based on the data and the previous longitudinal velocity for the previous time interval;
determining, by the VLLO component, a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle;
receiving, by a vehicle longitudinal dynamics observer (“VLDO”) component executed by the one or more processors, wheel speed sensor data for each of a plurality of wheels of the vehicle, tire pressure sensor data for each of the plurality of wheels of the vehicle, and steering angle sensor data;
determining, by the VLDO component, a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval;
selecting, by a vehicle side slip observer (“VSSO”) component executed by the one or more processors, one of a reduced-order nonlinear Luenberger observer technique or a reduced-order Kalman filter technique based on the confidence index of the VLLAO component and the confidence index of the VLDO component;
determining, by the VSSO component via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval; and
providing, by the VSSO component, lateral velocity and the sideslip angle for the current time interval to a vehicle controller to cause the vehicle controller to control movement of the vehicle.

10. The method of claim 9, comprising:
using, by the vehicle controller, the lateral velocity and the sideslip angle to maintain an adaptive cruise control functionality of the vehicle.

11. The method of claim 9, comprising:
receiving, by the VLLAO component, for the current time interval, data from the inertia measurement unit comprising acceleration among an x-axis, y-axis and a z-axis, and angular rate among the x-axis, y-axis, and the z-axis.

12. The method of claim 9, comprising:
determining, by the VLLAO component, the roll angle for the vehicle for the current time interval and the pitch angle for the vehicle for the current time interval based on an angles kinematic estimation function and a Kalman filter.

13. The method of claim 9, comprising:
determining, by the VLLAO component, the confidence index for the VLLO component for the current time interval via a fuzzy logic based noise covariance adjustment.

14. The method of claim 9, comprising:
determining, by the VLDO component, a wheel speed via a machine learning based anomaly detection function and the wheel speed sensor data for each of the plurality of wheels of the vehicle; and
determining, by the VLDO component, the confidence index of the VLDO component via a fuzzy logic based noise covariance adjustment.

15. The method of claim 9, comprising:
determining, by the VSSO component, a lumped confidence index based on the confidence index of the VLLAO component and the confidence index of the VLDO component; and
selecting, by the VSSO component, the reduced-order nonlinear Luenberger observer technique responsive to the lumped confidence index being greater than a threshold.

16. The method of claim 9, comprising:
determining, by the VSSO component, a lumped confidence index based on the confidence index of the VLLAO component and the confidence index of the VLDO component; and
selecting, by the VSSO component, the reduced-order Kalman filter technique responsive to the lumped confidence index being less than or equal to a threshold.

17. A vehicle, comprising:
a data processing system comprising one or more processors and memory;
a vehicle longitudinal and lateral observer (“VLLO”) component executed by the one or more processors to:
identify, for a previous time interval, a previous longitudinal velocity of the vehicle;
receive, for a current time interval, data from an inertia measurement unit of the vehicle;
determine a roll angle for the vehicle for the current time interval and a pitch angle for the vehicle for the current time interval based on the data and the previous longitudinal velocity for the previous time interval;
determine a lateral acceleration of the vehicle for the current time interval, a longitudinal acceleration of the vehicle for the current time interval, and a confidence index for the VLLO component for the current time interval based on the data from the inertia measurement unit, the roll angle, and the pitch angle;
a vehicle longitudinal dynamics observer (“VLDO”) component executed by the one or more processors to:
receive wheel speed sensor data for each of a plurality of wheels of the vehicle, tire pressure sensor data for each of the plurality of wheels of the vehicle, and steering angle sensor data;
identify the previous longitudinal velocity for the previous time interval;
identify the lateral acceleration and the longitudinal acceleration for the current time interval determined by the vehicle longitudinal and lateral observer component;
determine a longitudinal velocity for the current time interval and a confidence index for the VLDO component based on the wheel speed sensor data for each of the plurality of wheels of the vehicle, the tire pressure sensor data for each of the plurality of wheels of the vehicle, the steering angle sensor data, the longitudinal velocity for the previous time interval, and the lateral acceleration and the longitudinal acceleration for the current time interval;
a vehicle side slip observer (“VSSO”) component executed by the one or more processors to:
select one of a reduced-order nonlinear Luenberger observer technique or a reduced-order Kalman filter technique based on the confidence index of the VLLAO component and the confidence index of the VLDO component;
determine, via the selected one of the reduced-order nonlinear Luenberger observer technique or the reduced-order Kalman filter technique, a lateral velocity and a sideslip angle of the vehicle for the current time interval based on the longitudinal velocity, the lateral acceleration, and the longitudinal acceleration for the current time interval; and
provide the lateral velocity and the sideslip angle for the current time interval to a vehicle controller to cause the vehicle controller to control movement of the vehicle.

18. The vehicle of claim 17, comprising:
the vehicle controller to use the lateral velocity and the sideslip angle to maintain an adaptive cruise control functionality of the vehicle.

19. The vehicle of claim 17, comprising:
the VLLAO component to receive, for the current time interval, data from the inertia measurement unit comprising acceleration among an x-axis, y-axis and a z-axis, and angular rate among the x-axis, y-axis, and the z-axis.

20. The vehicle of claim 17, comprising the VSSO component to:
determine a lumped confidence index based on the confidence index of the VLLAO component and the confidence index of the VLDO component; and
select the reduced-order nonlinear Luenberger observer technique responsive to the lumped confidence index being greater than a threshold.
